(19) United States
(12) Patent Application Publication
(10) Pub. No.: US 2014/0136185 A1
(43) Pub. Date: May 15, 2014

(54) SENTIMENT ANALYSIS BASED ON DEMOGRAPHIC ANALYSIS

(71) Applicant: INTERNATIONAL BUSINESS MACHINES CORPORATION, Armonk, NY (US)

(72) Inventor: Dhruv A. Bhatt, Indian Trail, NC (US)

(73) Assignee: INTERNATIONAL BUSINESS MACHINES CORPORATION, Armonk, NY (US)

(21) Appl. No.: 13/675,653

(22) Filed: Nov. 13, 2012

(51) Int. Cl. G06F 17/27

(52) U.S. Cl. CPC G06F 17/2785
USPC 704/9

(57) ABSTRACT

A method, apparatus and article of manufacture for analyzing product or service reviews is disclosed. In one embodiment, the method comprises the steps of performing a demographic text analysis on a product or service review generated by a reviewer, wherein the demographic text analysis examines the product or service review to determine demographic information of the reviewer. A sentiment text analysis is performed on the product or service review, wherein the sentiment text analysis examines the product or service review to determine a sentiment of the product or service review. The sentiment of the product or service review is categorized based on the demographic information of the reviewer.

### BACKGROUND OF THE INVENTION

The present invention relates generally to systems and methods for analyzing user-generated content such as reviews and comments of goods and services, and in particular, to a system and method for analyzing and categorizing the sentiment of reviews of a good or service based on reviewer demographics.

### SUMMARY OF THE INVENTION

The invention disclosed herein has a number of embodiments useful, for example, in analyzing user-generated content, such as product or service reviews. Illustrative embodiments include a method, computer program product, and article of manufacture for determining the sentiment of the reviews of a product or service and further organizing and presenting such sentiment information to a user or company doing product research based on the demographics of the reviewers.

In one aspect of the present disclosure, a computer implemented method for analyzing product or service reviews is provided. The method comprises the steps of performing a demographic text analysis on a product or service review generated by a reviewer, wherein the demographic text analysis examines the product or service review to determine demographic information of the reviewer. A sentiment text analysis is performed on the product or service review, wherein the sentiment text analysis examines the product or service review to determine a sentiment of the product or service review. The sentiment of the product or service review is categorized based on the demographic information of the reviewer.

In one embodiment of the invention, the computer implemented method further comprises a step of generating a report of the sentiment of a plurality of product or service reviews categorized by the demographic information of the reviewers. In certain embodiments, the demographic information is at least one of a gender, race, age, disability, mobility, home ownership, employment status, location, etc. and the sentiment is one of a positive or negative sentiment. In further embodiments, the demographic text analysis and sentiment text analysis utilize UIMA dictionaries and parsing rules to examine the product or service review.

### BRIEF DESCRIPTION OF THE DRAWINGS

Referring now to the drawings in which like reference numbers represent corresponding parts throughout:

FIG. 1 is a diagram illustrating an exemplary network data processing system that could be used to implement elements of the present invention;

FIG. 2 is a diagram illustrating an exemplary data processing system that could be used to implement elements of the present invention;

FIG. 3 is a diagram illustrating an exemplary data processing system that could be used to implement elements of the present invention; and

FIG. 4 is a diagram illustrating exemplary process steps that can be used to practice one embodiment of the present invention.

### DETAILED DESCRIPTION OF THE INVENTION

In the following description, reference is made to the accompanying drawings which form a part hereof, and in which is shown by way of illustration a specific embodiment in which the invention may be practiced. It is to be understood that other embodiments may be utilized and structural and functional changes may be made without departing from the scope of the present invention.

### OVERVIEW

Oftentimes, a user may see sentiment analysis of reviews of products, but have no idea of the demographic of the reviewers. Such knowledge is useful because, for example, if there are ten positive reviews from users between the ages of thirteen and nineteen years old, but the targeted users are between sixty and seventy years old, then those reviews would not be as relevant or helpful as ten positive reviews from people who are of the same age group as the targeted users. This is because desired features and the choice of products often differ based on demographics. Thus, sentiment analysis based on demographics provides a new and useful perspective for users viewing product reviews.

A system and method is provided that determines the sentiment and demographic information of product or service reviews through automated text analytics and further organizes and presents such sentiment information to a user based on the demographics of the reviewers.

In one embodiment of the invention, the sentiment analysis of the review and also the demographic analysis of the same review are performed using text analytics technology, such as UIMA dictionaries and parsing rules and other UIMA-like technology. UIMA is a component software architecture for the development, discovery, composition and deployment of multi-modal analytics for the analysis of unstructured information and its integration with search technologies. A more detailed reference of UIMA can be obtained from the APACHE SOFTWARE FOUNDATION at http://uima.apache.org/uima-specification.html.

Such text analytics technology is used to determine the demographic of the author of the review and the sentiment of the review, and combine them together to provide a company or user with deep insight into the reviews. As long as demographic information can be acquired, extracted, or inferred, the use of demographics to fine tune sentiment analytics may be used in several different ways to provide richer analytics.

### Hardware and Software Environment

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

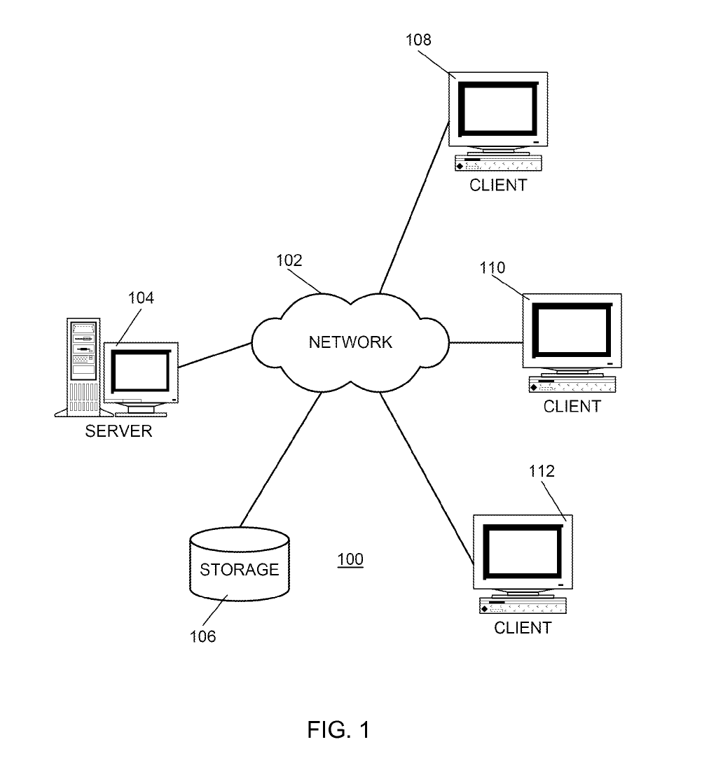

With reference now to FIG. 1, a pictorial representation of a network data processing system 100 is presented in which the present invention may be implemented. Network data processing system 100 contains a network 102, which is the medium used to provide communications links between various devices and computers connected together within network data processing system 100. Network 102 may include connections, such as wire, wireless communication links, or fiber optic cables etc.

In the depicted example, server 104 is connected to network 102 along with storage unit 106. In addition, clients 108, 110, and 112 are connected to network 102. These clients 108, 110, and 112 may be, for example, personal computers or network computers. In the depicted example, server 104 provides data, such as boot files, operating system images, and programs to clients 108, 110 and 112. Clients 108, 110 and 112 are clients to server 104. Network data processing system 100 may include additional servers, clients, and other devices not shown. In the depicted example, network data processing system 100 is the Internet with network 102 representing a worldwide collection of networks and gateways that use the TCP/IP suite of protocols to communicate with one another.

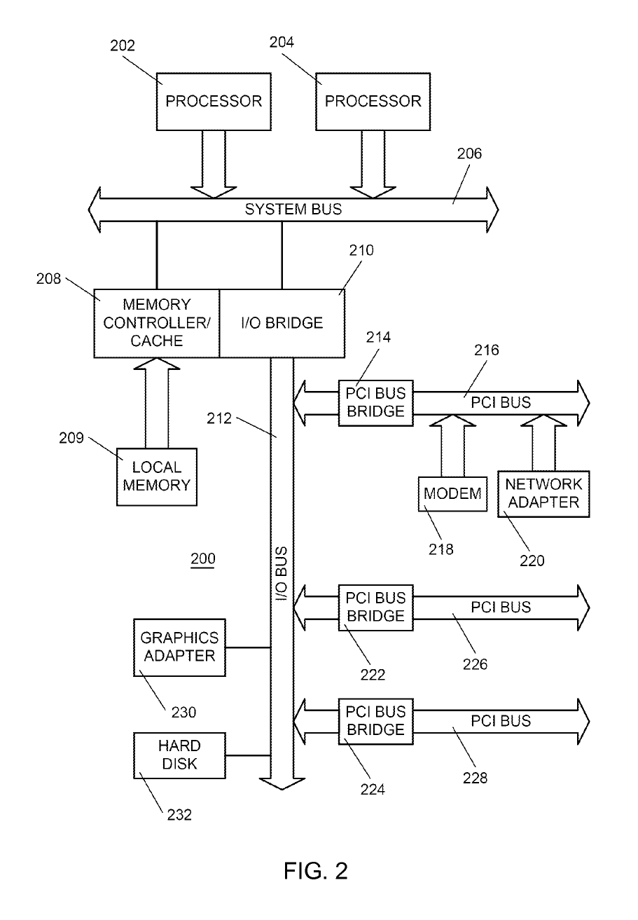

Referring to FIG. 2, a block diagram of a data processing system that may be implemented as a server, such as server 104 in FIG. 1, is depicted in accordance with an embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to network computers 108, 110 and 112 in FIG. 1 may be provided through modem 218 and network adapter 220 connected to PCI local bus 216 through add-in boards. Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM e-Server pSeries system, a product of International Business Machines Corporation in Armonk, N.Y., running the Advanced Interactive Executive (AIX) operating system or LINUX operating system.

Server 104 may provide a suitable website or other internet-based graphical user interface accessible by users to enable user interaction for aspects of an embodiment of the present invention. In one embodiment, Netscape web server, IBM Websphere Internet tools suite, an IBM DB2 for Linux, Unix and Windows (also referred to as “IBM DB2 for LUW”) platform and a Sybase database platform are used in conjunction with a Sun Solaris operating system platform. Additionally, components such as JBDC drivers, IBM connection pooling and IBM MQ series connection methods may be used to provide data access to several sources. The term webpage as it is used herein is not meant to limit the type of documents and programs that might be used to interact with the user. For example, a typical website might include, in addition to standard HTML documents, various forms, Java applets, JavaScript, active server pages (ASP), Java Server Pages (JSP), common gateway interface scripts (CGI), extensible markup language (XML), dynamic HTML, cascading style sheets (CSS), helper programs, plug-ins, and the like.

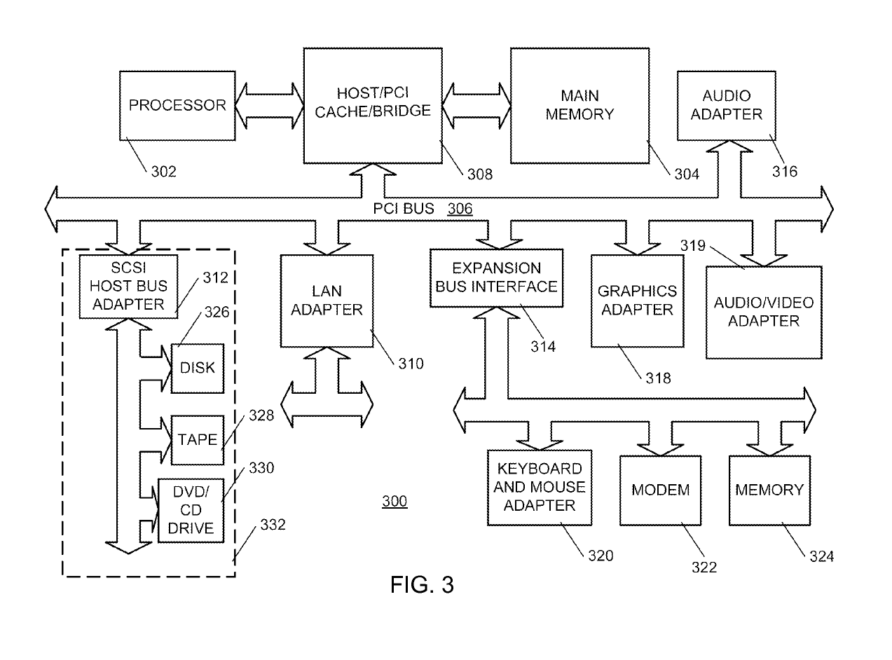

With reference now to FIG. 3, a block diagram illustrating a data processing system is depicted in which aspects of an embodiment of the invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, Small computer system interface (SCSI) host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots.

Expansion bus interface 314 provides a connection for a keyboard and mouse adapter 320, modem 322, and additional memory 324. SCSI host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows XP®, which is available from Microsoft Corporation. An object oriented programming system such as Java may run in conjunction with the operating system and provide calls to the operating system from Java programs or programs executing on data processing system 300. “Java” is a trademark of Sun Microsystems, Inc. Instructions for the operating system, the object-oriented operating system, and programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash ROM (or equivalent nonvolatile memory) or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interface, whether or not data processing system 300 comprises some type of network communication interface. As a further example, data processing system 300 may be a Personal Digital Assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 may also be a notebook computer or hand held computer as well as a PDA. Further, data processing system 300 may also be a kiosk or a Web appliance. Further, the present invention may reside on any data storage medium (i.e., floppy disk, compact disk, hard disk, tape, ROM, RAM, etc.) used by a computer system. (The terms “computer,” “system,” “computer system,” and “data processing system” and are used interchangeably herein.)

### Sentiment Analysis Based on Demographic Analysis

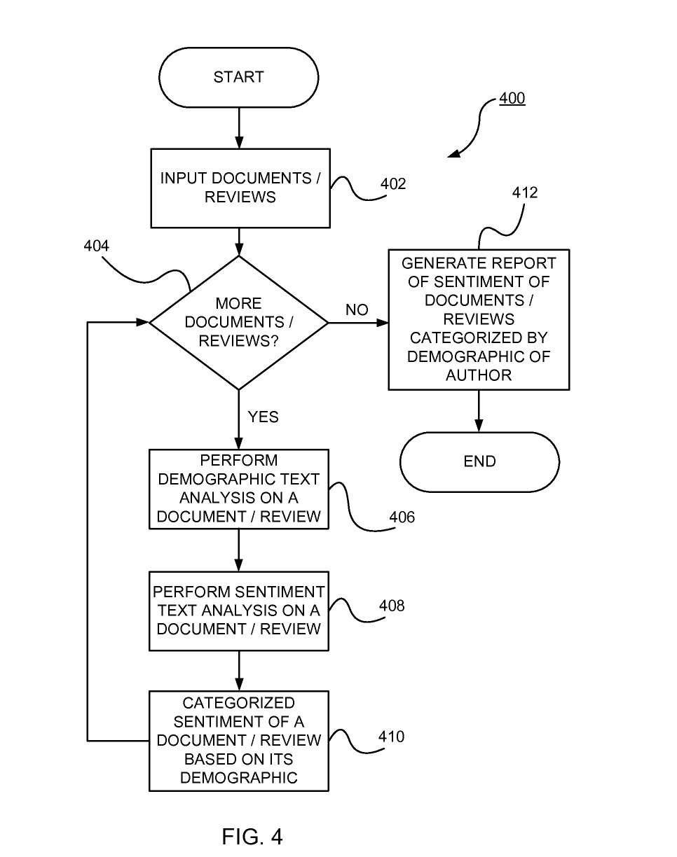

In the network data processing system 100, the server 104 interacts with the clients 108, 110, 112 to obtain product or service reviews from users, which may be stored in the storage unit 106. The server 104 performs an analysis of the sentiment and demographic information found in the product or service reviews through automated text analytics and further organizes and presents such sentiment information to a user based on the demographics of the reviewers. The sentiment analysis of the review and also the demographic analysis of same review are performed by the server 104 using text analytics technology, such as UIMA dictionaries and parsing rules and other UIMA-like technology. Such text analytics technology is used by the server 104 to determine the demographic of the author of the review and the sentiment of the review, and combine them together to provide a company or user with deep insight into the reviews. As long as demographic information can be acquired, extracted, or inferred, the use of demographics to fine tune sentiment analytics may be used in several different ways to provide richer analytics. These steps are further described in FIG. 4.

FIG. 4 is a flow chart illustrating exemplary process steps that can be used to practice one embodiment of the present invention. In one aspect of the present disclosure, a computer implemented method 400 for analyzing product or service reviews is provided.

In block 402, user-generated content such as documents and reviews are inputted.

In decision block 404, a determination is made as to whether more documents or reviews of a product or service are available for analysis. If no additional documents or reviews of a product or service are provided, a report of the document or review of the product or service is generated, as shown in block 412, and the computer implemented method 400 ends.

If there are more documents or reviews of the product or service available for analysis, demographic text analysis is performed on a document or review of the product or service, as shown in block 406. The demographic text analysis examines the product or service review to determine demographic information of the reviewer. Demographic specific dictionaries and parsing rules are used to determine a domain of reviews. In specific embodiments, demographic text analysis utilizes UIMA dictionaries and parsing rules to examine the product or service review. Demographic specific dictionaries contain words and phrases used by a specific demographic. For example, the phrase “that's cool” is found in a demographic dictionary for users between thirteen and nineteen years old. In certain embodiments, the demographic information is an age range. In other embodiments, the demographic information includes, but is not limited to, gender, race, age, disability, mobility, home ownership, employment status, location, etc.

In block 408, sentiment text analysis is performed on the document or review of the product of service. The sentiment text analysis examines the product or service review to determine a sentiment of the product or service review. Dictionaries and parsing rules are used to determine the sentiment of a review. In specific embodiments, sentiment text analysis utilizes UIMA dictionaries and parsing rules to examine the product or service review. In certain embodiments, the sentiment is one of a positive or negative sentiment. Positive and negative sentiment dictionaries contain words and phrases used for positive and negative sentiment. For example, words such as “great”, “awesome”, “nice feature”, etc., are part of a positive sentiment dictionary and words such as “hate” and “terrible”, etc., are part of a negative sentiment dictionary. Parsing rules utilize such dictionaries to determine if the sentiment is positive or negative. For example, the phrase “I hate xyz” is marked as a negative sentiment because the word “hate” is part of the negative sentiment dictionary. A more complex phrase such as “I do not like xyz” is also marked as a negative sentiment, even though the word “like” is part of the positive sentiment dictionary, because the word “like” is preceded by the negation “not”. The parsing rules are able to take into account such situations.

In block 410, the sentiment of the document or review is categorized based on the demographic information of the reviewer. In certain embodiments, the sentiment of the document or review is categorized based on the age range of the reviewer. In other embodiments, the demographic information is categorized based on at least one of a gender, race, age, disability, mobility, home ownership, employment status, location, etc.

The process then returns back to decision block 404, where a determination is made as to whether there are any more documents or reviews of the product or service to be analyzed and categorized. If there are more documents or reviews of the product or service that have not yet been analyzed and categorized, blocks 404, 406, 408, and 410 are repeated until all the documents or reviews of the product or service have been analyzed and categorized.

If there are no more documents or reviews of the product or service that need to be analyzed, a report of the sentiment of the documents or reviews as categorized by the demographic of the author is generated, as shown in block 412, and the computer implemented method 400 ends. In preferred embodiments, a report of the sentiment of a plurality of product or service reviews categorized by the demographic information of the reviewers is generated.

The flowchart and block diagrams in the Figures discussed above illustrate the architecture, functionality, and operation of possible implementations of systems, methods and computer program products according to various embodiments of the present invention. It should be noted that, in some alternative implementations, the functions noted in the blocks may occur out of the order noted in the Figures. For example, blocks 406 and 408, which are shown in succession in FIG. 4 may, in other embodiments of the invention, be executed substantially concurrently, or may be executed in the reverse order (i.e., first performing sentiment analysis 408 on a document/review followed by performing demographic text analysis 406 on a document/review).

### CONCLUSION

This concludes the description of the preferred embodiments of the present invention. The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A computer implemented method for analyzing a product or service review, comprising:
performing, on one or more computers, a demographic text analysis on a review generated by a reviewer, wherein the demographic text analysis examines the review to determine demographic information of the reviewer;
performing, on one or more computers, a sentiment text analysis on the review, wherein the sentiment text analysis examines the review to determine a sentiment of the review; and
categorizing, on one or more computers, the sentiment of the review based on the demographic information of the reviewer.

2. The method of claim 1, further comprising generating a report of the sentiment of a plurality of reviews categorized by the demographic information of the reviewers.

3. The method of claim 1, wherein the demographic information is an age range.

4. The method of claim 1, wherein the demographic information is one of a gender, race, age, disability, mobility, home ownership, employment status, and location.

5. The method of claim 1, wherein the sentiment is a positive sentiment.

6. The method of claim 1, wherein the sentiment is a negative sentiment.

7. The method of claim 1, wherein the demographic text analysis and sentiment text analysis utilize an Unstructured Information Management Architecture (UIMA) dictionary and parsing rules to examine the product review.

8. A computer-implemented apparatus for analyzing a product or service review, comprising:
one or more computers; and
one or more processes performed by the one or more computers, the processes configured to:
perform a demographic text analysis on a review generated by a reviewer, wherein the demographic text analysis examines the review to determine demographic information of the reviewer;
perform a sentiment text analysis on the review, wherein the sentiment text analysis examines the review to determine a sentiment of the review; and
categorize the sentiment of the review based on the demographic information of the reviewer.

9. The apparatus of claim 8, wherein the process are configured to generate a report of the sentiment of a plurality of reviews categorized by the demographic information of the reviewers.

10. The apparatus of claim 8, wherein the demographic information is an age range.

11. The apparatus of claim 8, wherein the demographic information is one of a gender, race, age, disability, mobility, home ownership, employment status, and location.

12. The apparatus of claim 8, wherein the sentiment is a positive sentiment.

13. The apparatus of claim 8, wherein the sentiment is a negative sentiment.

14. The apparatus of claim 8, wherein the demographic text analysis and sentiment text analysis utilize an Unstructured Information Management Architecture (UIMA) dictionary and parsing rules to examine the review.

15. A computer program product for analyzing a product or service review, said computer program product comprising:
a computer readable storage medium having stored/encoded thereon:
first program instructions executable by a computer to cause the computer to perform a demographic text analysis on a review generated by a reviewer, wherein the demographic text analysis examines the review to determine demographic information of the reviewer;
second program instructions executable by the computer to cause the computer to perform a sentiment text analysis on the review, wherein the sentiment text analysis examines the review to determine a sentiment of the review; and
third program instructions executable by the computer to cause the computer to categorize the sentiment of the review based on the demographic information of the reviewer.

16. The computer program product of claim 15, further comprising fourth program instructions executable by the computer to cause the computer to generate a report of the sentiment of a plurality of reviews categorized by the demographic information of the reviewers.

17. The computer program product of claim 15, wherein the demographic information is an age range.

18. The computer program product of claim 15, wherein the demographic information is one of a gender, race, age, disability, mobility, home ownership, employment status, and location.

19. The computer program product of claim 15, wherein the sentiment is a positive sentiment.

20. The computer program product of claim 15, wherein the sentiment is a negative sentiment.

21. The computer program product of claim 15, wherein the demographic text analysis and sentiment text analysis utilize an Unstructured Information Management Architecture (UIMA) dictionary and parsing rules to examine the review.
